(19) United States
(12) Patent Application Publication
(10) Pub. No.: US 2003/0161258 A1
(43) Pub. Date: Aug. 28, 2003

(54) Apparatus, and associated method, for a multiple-input, multiple-output communications system

(76) Inventors: Jianzhong Zhang, Irving, TX (US); Panayiotis D. Papadimitriou, Irving, TX (US); Prabodh Varshney, Coppell, TX (US)

Correspondence Address: SCHEEF & STONE, L.L.P., 5956 SHERRY LANE, SUITE 1400, DALLAS, TX, 75225, US

(21) Appl. No.: 10/080,933

(22) Filed: Feb. 22, 2002

(51) Int. Cl. H04J 11/00

(52) U.S. Cl. 370/203

(57) ABSTRACT

Apparatus, and an associated method, for a multiple-input, multiple-output communication system having M transmit antennas and N receive antennas. Apparatus is provided for the receiving station including processing elements permitting joint interference cancellation and prefiltering of data received at the receiving station. Additional joint encoding apparatus is provided for a sending station of the MIMO communication system together with corresponding decoding apparatus of the receiving station.

The present invention relates generally to a manner by which to communicate data in a MIMO (multiple-input, multiple-output) communication system. More particularly, the present invention relates to apparatus, and an associated method, by which jointly to perform interference cancellation and equalization prefiltering operations at a receiving station of the communication system. The present invention further relates to a joint encoding, and decoding, scheme for the MIMO communication system. The joint operations are of reduced complexity as the calculations required in their performance increase only linearly, not exponentially, with increases in the number of transmit antennas used in the MIMO communication system. And, the use of the joint encoding and decoding scheme provides improved communication performance of the system at a particular data rate.

### BACKGROUND OF THE INVENTION

Data is communicated during operation of a communication system between a sending station and a receiving station by way of a communication channel. Data sourced at the sending station is converted into a form to permit its communication upon the communication channel and then sent thereon. The receiving station detects the data communicated upon the communication channel and operates upon the detected data to recover the informational content thereof.

Many different types of communication systems have been developed and implemented through which to effectuate communication of data pursuant to performance of a communication service.

One exemplary type of communication system is a radio communication system. In a radio communication system, a communication path that connects communication endpoints and upon which a communication channel is defined includes a radio link. The radio link is defined upon a portion of the electromagnetic spectrum. Fixed, wireline connections are not required for the portion of the communication path that is formed of the radio link. The radio communication system is therefore inherently more mobile than a conventional, wireline communication system. The increased mobility results as the sending and receiving stations of a radio communication system are not connected by way of fixed, wireline connections.

A cellular communication system is a type of radio communication system that has achieved wide levels of usage. The networks of various types of cellular communication systems have been installed throughout significant portions of populated areas of the world. A subscriber to a cellular communication system is able to communicate therethrough pursuant to a service subscription for service in the communication system.

The subscriber to the cellular communication system utilizes a mobile station with which to communicate with structure of the network of the cellular communication system. Both the mobile station and the corresponding structure of the network with which the mobile station communicates form radio transceivers capable of both sending and receiving radio signals upon the radio links extending therebetween. Radio transceivers of the network part of a cellular communication system are referred to as base transceiver stations (BTSs) and, as just noted, radio transceivers carried by subscribers to the communication system are typically referred to as mobile stations, due, typically, to their mobility.

The communication channel formed between the communication stations, i.e., the base transceiver station and the mobile station, between which the data is communicated, is non-ideal. That is to say, the data communicated upon the communication channel is distorted during its propagation between the communication stations. If the distortion is significant, the informational content of the data cannot accurately be recovered once received.

Fading caused by multi-path transmission, for instance, might alter the values of information-bearing bits of the data during its transmission upon the communication channel. Various techniques are utilized to overcome the distortion introduced upon the data.

The redundancy of the transmitted data through time and coding of the data, prior to its transmission, is sometimes utilized to counteract the distortion introduced upon the data during its transmission upon the communication channel. By increasing the time redundancy of the data, the likelihood that the informational content of the data can be recovered, once received at the receiving station, is increased. Introducing time redundancy into the data is sometimes referred to as creating time diversity.

Space diversity is sometimes also utilized to overcome distortion introduced upon the data. Typically, space diversity refers to the utilization of more than one transmit antenna transducer from which data is transmitted, thereby to provide spatial redundancy.

Space and time diversity are sometimes utilized together, thereby further to enhance transmission diversity to combat signal fading caused, e.g., by multi-path transmission.

A receiving station sometimes also utilizes multiple numbers of antennas to facilitate reception of the data transmitted thereto. A communication system in which both multiple transmit antennas and multiple receive antennas are utilized is sometimes referred to as an MIMO (multiple-input, multiple-output) communication system. In such a communication system, independent data streams can be transmitted at different ones of the multiple transmit antennas. And, thereby, the potential throughput of data in such a communication system increases corresponding with the increase in the number of transmit antennas. That is to say, the potential data throughput increases linearly with the number of transmit antennas that are utilized. To realize the potential data throughput increase permitted through the use of an MIMO system, the receiving station must be able to reliably detect each of the individual data streams in the presence of interference that distorts the data caused both by inter-symbol interference (ISI) and interference caused by other data streams.

Joint detection of the multiple data streams at the receiving station is the optimal approach. However, complexity of equalization operations required to be performed at the receiving station increases exponentially, both with the number of transmit antennas and also with the length of a channel memory. The complexity of equalization operations is so significant as generally to limit the practical utility of such systems in many applications. While use of a properly-designed prefilter can shorten the channel length, and thus reduce the complexity of equalization operations, the complexity required of the equalization operations still limits its suitability for real-time applications.

Alternatively, a much less complex approach to joint detection of the multiple data streams is separate detection of the data streams. During detection of a particular data stream, other data streams are considered to be interference. In this equalization approach, receiver complexity increases only linearly with the number of transmit antennas, rather than the exponential increase resulting in joint detection equalization operations. A multiple step procedure, however, is typically required. That is, a space-time interference cancellation step is first required to be performed and, subsequent thereto, prefiltering/equalization with a decision feedback sequence estimation equalizer structure is performed. The need for use of a multiple-step process is, however, time-consumptive and otherwise disadvantageous.

Improved communication performance would be provided if an improved manner by which to operate upon received data at a receiving station could be provided without increasing the complexity of the receiving station.

Improved communication performance would also be provided if an improved manner by which to encode, and correspondingly decode, the data could be provided.

It is in light of this background information related to communications in an MIMO communication system that the significant improvements of the present invention have evolved.

### SUMMARY OF THE INVENTION

The present invention, accordingly, advantageously provides apparatus, and an associated method, by which to communicate data in an MIMO (multiple-input, multiple-output) communication system.

Through operation of an embodiment of the present invention, interference cancellation and decision-feedback-equalization prefiltering operations are performed jointly, thereby to provide single-step performance of such operations.

The joint operations result in reduced complexity as the calculations required in the equalization process increase only linearly with increases in the number of transmit antennas used in the MIMO communication system.

The present invention further advantageously provides a joint encoding, and corresponding decoding, scheme for the MIMO communication system. Use of the joint encoding and decoding schemes provide improved communication performance at a particular data rate when used in a MIMO communication system having a receiving station structure that jointly performs interference cancellation and equalization prefiltering operations.

In one aspect of the present invention, a processing element operates to generate values of parameters to be used by prefilter (feed forward filter) and feedback filter parameters of a decision feedback sequence estimator. The values of the parameters define optimal parameters by which the prefilter and feedback filters are to be operable upon indications of receive data received at the receiving station.

In another aspect of the present invention, separate functional receive chain tags are associated with each receive antenna of the receiving station in the MIMO communication system. Estimated data values of data received at each of the separate receive antennas is provided to the processing element. Values of the optimal feedback filter parameters and values of the optimal feed forward filter parameters are estimated responsive to estimated values of the data received at each of the separate receive antennas.

In another aspect of the present invention, a processing element calculates optimal values of the feed forward and feedback filter parameters, respectively, for each receive chain path. And, separate decision feedback sequence estimators are provided for each receive chain path of the receive station. The separate detected bitstreams are generated by separate ones of the decision feedback sequence estimators of the separate receive chain portions.

Thereby, a low-complexity, MIMO receive structure is provided in which interference cancellation and prefiltering operations are performed jointly, within a common step. Received signal vectors, forming the data communicated to the receive station, are processed by a series of space-time interference canceling and prefiltering filters. Each filter has a target data stream for both suppressing other data streams and for shortening effective channel impulse response of the desired data stream. The resultant structure has a low complexity corresponding to MQ^{L} wherein M is the number of transmit antennas, Q is the constellation size of the symbol scheme used in the communication system, and L is the shortened channel memory length.

In one implementation, the prefilter is unbiased. In another implementation, the prefilter is biased.

In another aspect of the present invention, a joint encoding scheme is provided for jointly encoding M-RLC blocks of data that are to be transmitted simultaneously at a sending station by way of M transmitting antennas. Through such joint encoding, improved gain levels can be achieved, as compared to a separate encoding scheme by which the M blocks of data are independently coded.

And, in another aspect of the present invention, a corresponding, decoding scheme is provided for the receive station. Through joint encoding and decoding of the data, improved gain, compared to conventional encoding schemes and corresponding decoding schemes, is provided.

In one implementation, a cellular communication system is implemented as an MIMO system. Base transceiver stations and mobile stations include multiple antenna sets implemented as an MIMO system. Equalization and coding operations are performed to provide improved gain levels of data communication, as well as estimation operations of reduced complexity levels.

In these and other aspects, therefore, apparatus, and an associated method, is provided for a multiple-input, multiple-output communication system. The communication system has a receiving station that receives at least a first data vector transmitted thereto. The data vector is transmitted upon a communication channel, and, when received at the receiving station, the at least the first data vector is formed of received symbols. Operations are performed upon the data vector, once received at the receiving station. At least a first processing element is coupled to receive indications of the at least the first data vector received at the receiving station. The first processing element forms optimized feed forward filter parameters and optimized feedback filter parameters. The optimized feed forward and feedback filter parameters are used to perform interference cancellation and prefilter operations at the receiving station.

A more complete appreciation of the present invention and the scope thereof can be obtained from the accompanying drawings that are briefly summarized below, the detailed description of the presently preferred embodiments of the invention, and the appended claims.

### BRIEF DESCRIPTION OF THE DRAWINGS

FIG. 1 illustrates a functional block diagram of an MIMO communication system in which an embodiment of the present invention is operable.

FIG. 2 illustrates a functional block diagram of a portion of a receiving station that forms part of the communication system shown in FIG. 1.

FIG. 3 illustrates another functional block diagram of a portion of the receiving station that forms part of the communication system shown in FIG. 1.

FIG. 4 illustrates a functional block diagram of a portion of the sending station that forms part of the communication system shown in FIG. 1 pursuant to an embodiment of the present invention.

FIG. 5 illustrates another functional block diagram of a portion of a receiving station that forms part of the communication system shown in FIG. 1 pursuant to an embodiment of the present invention.

FIG. 6 illustrates a method flow diagram that lists the method steps of the method of operation of an embodiment of the present invention.

### DETAILED DESCRIPTION

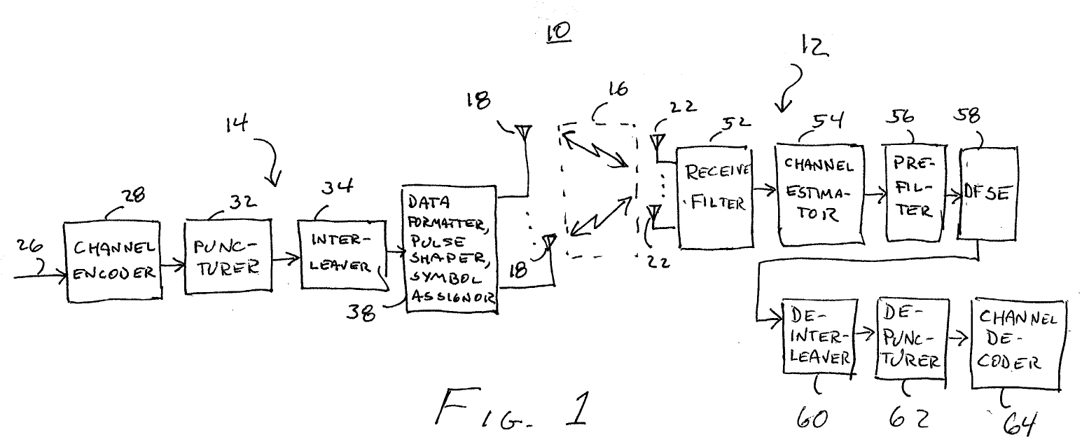

Referring first to FIG. 1, a communication system, shown generally at 10, provides for communications between remotely-positioned communication stations, here a cellular communication system operable pursuant to a second/third generation (2G/3G) communication standard, such as GSM/GPRS/EGPRS (global system for mobile communication/general packet radio service/enhanced general packet radio service) communication standard. The communication system 10 is representative also of other types of cellular, and other, communication systems. An embodiment of the present invention can, analogously, be implemented in other types of cellular, and other, communication systems, such as a WCDMA (wideband, code-division, multiple-access) communication system, as well as other types of radio, and other, communication systems.

Also, while the following description shall describe operation of the communication system on the forward link, that is, of communication of data by the base transceiver station 14 to the mobile station 12, i.e., in which the base transceiver station forms the sending station and the mobile station 12 forms the receiving station, an embodiment of the present invention can also be implemented in which the mobile station 12 forms the sending station and the base transceiver station 14 forms the receiving station. And, more generally, in any communication system that provides for duplex communications, the communication stations operable pursuant to a communication session are capable both of sending and receiving data, and each communication station operates as both a sending station and a receiving station. Embodiments of the present invention are implementable at both the transmit and receive parts of the communication stations.

Here, the station 14 includes a plurality of M transmit antennas 18, and the station 12 includes a plurality of N receive antennas 22. Transmit circuitry of the sending station formed of the base transceiver station to be transmitted simultaneously upon the radio link 16. In the exemplary implementation, separate blocks of data are transmitted at separate ones of the transmit antennas 18.

Each receive antenna of the receiving station formed of the mobile station 12 receives indications of the data blocks transmitted at the M transmit antenna 18. In the exemplary implementation, the number N is at least as great as the number M.

Because of the multiple number of transmit antennas permitting parallel transmission of separate data blocks, relatively large data throughput rates are potentially possible during operation of the MIMO system 10. However, because the receive antenna 22 of the receiving station receives data transmitted by each of the transmit antennas, significant processing is required at the receive station to recover the informational content of the data sent by each of the separate antennas. Operation of an embodiment of the present invention provides a manner by which to facilitate recovery of the informational content of the data transmitted by the separate transmit antennas that necessitate only relatively low-capacity processing at the receive station.

Functional elements of the sending station formed of the base transceiver station 14 include a channel encoder 28, coupled to the lines 26 to receive indications of the data that is to be sent to the receiving station. The channel encoder encodes the data and provides the data to a puncturer 32 that operates to puncture selected portions of the encoded data. And, the puncturer is coupled to an interleaver 34 that operates to interleave selected parts of the encoded, punctured data provided thereto. And, as indicated by the block 38, data formatting, pulse shaping, and symbol assigning functions are performed to convert the data into form to facilitate its communication by way of the radio link 16 to the receiving station. The element 38 is coupled to the transmit antennas 18.

The receiving station also includes functional elements that operate upon data detected by the receive antennas 22. A receive filter is coupled to the receive antennas to at least suppress out-of-band interference. Subsequent to receive filtering of the data at the receive filter 52, channel estimation operations are performed by the channel estimator 54. Estimated values are prefiltered by a prefilter 56. And, once prefiltered, the data is estimated by a direct feedback, sequence estimator (DFSE) 58 and thereafter de-interleaved by a de-interleaver 60, de-punctured by a de-puncturer 62, and decoded by a channel decoder 64.

An embodiment of the present invention is implemented at the receive station to facilitate recovery of the informational content of the data transmitted by the plurality of transmit antennas upon the radio link to the receive station. A lowered-complexity structure, relative to conventional manners by which to operate upon the data, is provided. Lowered-complexity calculations are performed to perform interference cancellation operations and to perform prefiltering operations at an MMSE-DFE prefilter. Through operation of an embodiment of the present invention, data streams are detected individually rather than jointly, and, in terms of algorithm performance, improvement is achieved by joint interference cancellation and prefiltering.

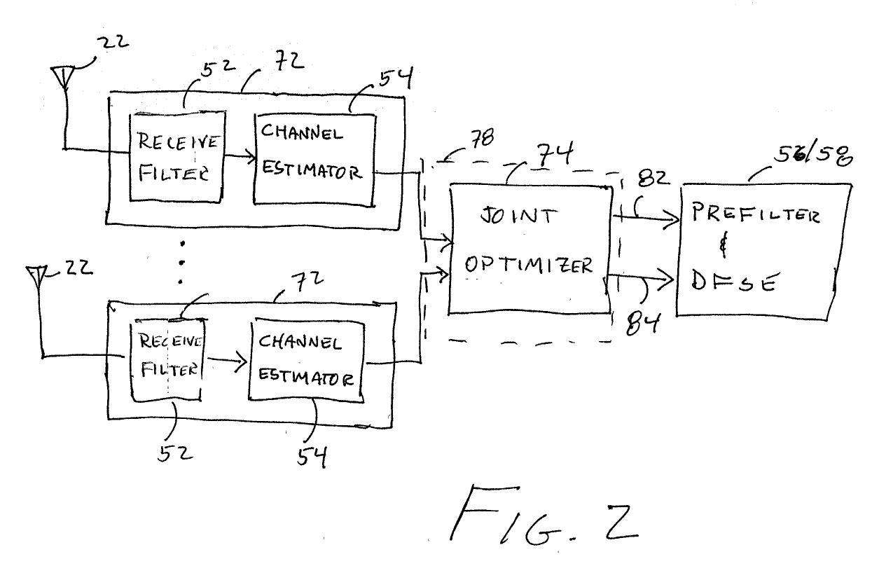

FIG. 2 illustrates a portion of the receiving station formed of the mobile station 12 of the communication system 10 shown in FIG. 1. Here, separate receive chain portions 72, associated with each of the receive antennas 22. And, part of an additional receive chain portion is also shown. Other receive chain portions can analogously be represented.

With respect to the top-most (as shown) receive chain portion 72, coupled to a top-most (as shown) receive antenna 22, the received data is filtered by a receive filter 52. Here, the functionality of the receive filters are separately represented at each of the receive chain portions. Again, subsequent to receive filteringoperations performed upon the detected data, joint channel estimation is performed by a channel estimator 54. The channel estimator performs channel estimation functions and, thereafter, values are provided to a joint optimizer 74. Other receive chain portions of the receiving station also include corresponding joint optimizer and are coupled to receive indications of values formed by the channel estimator. And, correspondingly, other receive chain portions provide indications of channel estimations performed at such other receive chain portions to the joint optimizer 74 of the top-most (as shown) receive chain portion. The joint optimizer 74 of the receive chain portion define the apparatus 78 of an embodiment of the present invention. Each joint optimizer operates, in manners that shall be described in greater detail below, to generate optimal parameter values to be used for subsequent operations at the receive chain portion.

Here, the joint optimizer 74 generates optimal parameter values on the lines 82 and 84. Other processing elements of other receive chain portions analogously generate corresponding optimal parameter values for use at other such receive chain portions.

Values generated by the joint optimizer 74 on the lines 82 and 84 are provided to a prefilter and decision feedback sequence estimator 56/58. Other receive chain portions analogously include corresponding functional elements to which corresponding values formed by corresponding joint optimizer are applied.

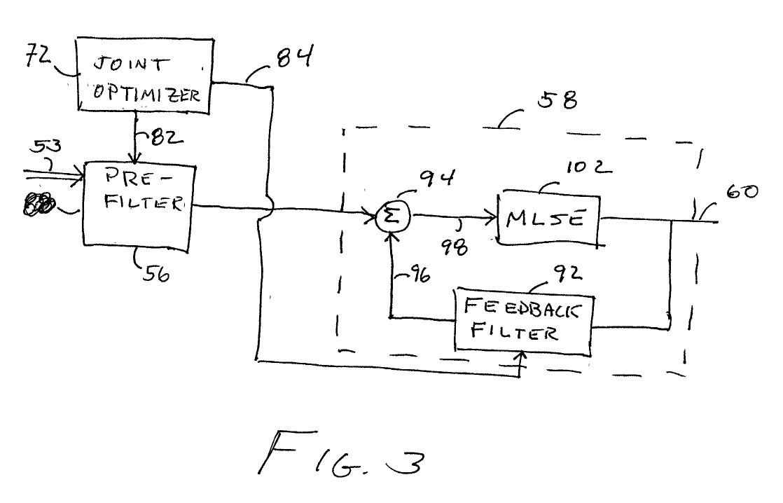

FIG. 3 again illustrates the joint optimizer 74 and the lines 82 and 84 upon which optimal parameter values, calculated at the processing element are here shown to be provided to a prefilter 56 and a feedback filter 92, respectively. Values representative of the data detected at the receive antenna 22, and filtered by a receive filter on the lines 53 are also shown to be provided to the prefilter. Prefiltering operations are performed upon the representations of the data provided thereto on the lines 53 in which the filter characteristics of the prefilter are determined by values of the optimal feedforward prefilter characteristics generated on the lines 82.

Prefiltered values are provided to the decision feedback sequence estimator 58. And, more particularly, the values provided to the DFSE are summed thereat, indicated at the summing element 94 together with values generated by the feedback filter 92 on the line 96. Summed values are generated on the line 98 and provided to an MLSE (maximum likelihood sequence estimator) 102. Maximum-likelihood values are generated on the line 60, and the line 60 extends to other receive chain portion elements (not shown) and to the feedback filter 92. The filter characteristics of the feedback filter are defined by the optimal parameter values provided thereto on the line 84. The feedback filter operates to filter the values provided thereto on the line 60 and to generate feedback-filtered values on the line 96. Operation of the joint optimizer 74 at the separate receive chain portions are represented mathematically below wherein the following designations are utilized:

| | |
|---|---|
| M: | number of transmit antennas, |
| N: | number of receive antennas, |
| L + 1: | length of the channel impulse response |
| K + 1: | length of the canceling/prefiltering filter length |
| S: | over-sampling rate, 2 or 4, |
| x: | transmitted symbols, |
| y: | over-sampled signal vector at the output of receive filter, |
| h: | channel impulse response (includes transmit filter, receive filter |
| | and physical channel), |
| w_{f}: | space-time interference cancellation filter, |
| w_{b}: | feed-forward filter |
| z: | symbol spaced signal vector at the output of the space-time filter |

In the baseband part of a receive chain, the over-sampled received signal vector at the output of an anti-aliasing filter at a receive antenna 22 and time k is:

$${\hat{y}}_{n , k} = {\sum }_{l = 0}^{L} {\sum }_{m = 1}^{M} {h}_{n , m , {l}^{x} m , k - l} + {n}_{n , k} n = 1 , … , N$$

Where ŷ_{n,k}=[y_{n,k,l}, . . . y_{n,k,S}]^{T} the over-sampled received signal vector and h_{n,m,l}=[h_{n,m,l,1}, . . . h_{n,m,l,S}]^{T} is the over-sampled lth tap channel coefficient between nth receive and mth transmit antenna 18. Meanwhile, S is the over-sampling rate and x_{m,k} is the transmitted symbol at transmit antenna m and time k.

Since space-time filtering operates across all the receive antennas with a temporal memory of K+1, the sampled received vectors can be represented in the following manner:

$${y}_{k} = [ \begin{matrix}{\hat{y}}_{k + K} \\ {\hat{y}}_{k + K - 1} \\ ⋮ \\ {\hat{y}}_{k}\end{matrix} ] = {\sum }_{m = 1}^{M} [ \begin{matrix}{\hat{h}}_{m , 0} & ⋯ & {\hat{h}}_{m , L} & & \\ & {\hat{h}}_{m , 0} & & {\hat{h}}_{m , L} & \\ & & ⋰ & & ⋰ \\ & & & {\hat{h}}_{m , 0} & {\hat{h}}_{m , L}\end{matrix} ] [ \begin{matrix}{x}_{m , k + K} \\ {x}_{m , k + K - 1} \\ ⋮ \\ {x}_{m , k - L}\end{matrix} ] + [ \begin{matrix}{n}_{k + K} \\ {n}_{k + K - 1} \\ ⋮ \\ {n}_{k}\end{matrix} ] { Δ}_{=} {\sum }_{m = 1}^{M} {H}_{m} {x}_{m , k} + {n}_{k}$$

where ŷₖ=[ŷ_{1,k}^{T}. . . ,ŷ_{N,k}^{T}]^{T} is the over-sampled received vector across all received antennas at time k, and ĥ_{m,l}=[h_{1,m,l}^{T}, . . . , h_{N,m,l}^{T}]^{T} is the over-sampled lth tap channel coefficients across all receive antennas for the channels originated from the mth transmit antenna.

There will be a total of M space-time filters, each producing an output stream zₘ that contains the signal part of xₘ with shortened effective channel impulse response and the suppressed interference xₚ,p≠m, x₁ is the desired signal and derive the space-time filter W_{f1}.

An MMSE-DFE structure of the prefilter/equlier pair is shown in FIG. 3. There are two filters: the feedforward filter 88 which is the space-time prefilter w_{f1} and the feedback filter 92 w_{b1}. At time k, the signal at the input of the MLSE equalizers is:

z_{1,k}=w_{f1}^{H}yₖ−w_{b1}^{H}x_{1,k,p}

Where yₖ is defined as above and x_{q,k,p}=[x_{1,k-1}, . . . ,x_{1,k-L}]^{T} is the previously detected symbols at time k where ‘p’ stands for ‘pre-cursor’. Note in mathematical analysis, perfect feedback is assumed, i.e., all the previously detected symbols are correct. Minimizing the mean square error (MSE) between z_{1,k} and x_{1,k} is, to this end, the optimal, designated by “t” prefilter w_{b1} can be obtained by:

w_{f1}⁺,w_{b1}⁺=arg min_{w}_{_{f1}}_{w}_{_{b1}}E∥z_{1,k}−x_{1,k}∥²=arg min_{w}_{_{fl}}_{w}_{_{bq}}E∥w_{f1}^{H}yₖ−w_{b1}^{H}x_{1,k,p}−x_{1,k}∥².

The Wiener filter approach is herein. First, equation 2 is rewritten as follows:

$${y}_{k} = {H}_{1 , p} {x}_{1 , k , p} + {H}_{1 , c} {x}_{1 , k , c} + {\sum }_{m = 2}^{M} {H}_{m} {x}_{m , k} + {n}_{k}$$

where x_{1,k,p} is defined as above and x_{1,k,c}=[x_{1,k+K} . . . x_{1,k}]^{T} is the causal part of the input data vector. Accordingly, H_{1,p} and H_{1,c} are the corresponding pre-cursor and causal parts of channel matrices. That is, H₁=└H_{1,c}H_{1,p}┘ and x_{1,k}=[x_{1,k,c}^{T}x_{1,k,p}^{T}]^{T}. Substitution into the above equation obtains the following:

$${{w}_{f 1}^{+} , {w}_{b 1}^{+} = arg {min}_{w} E ‖ [ {w}_{f 1}^{H} \vert {w}_{b 1}^{H} ] [ \frac{{H}_{1 , c} {x}_{1 , k , c} + {H}_{1 , p} {x}_{1 , k , p} + {\sum }_{m = 2}^{M} {H}_{m} {x}_{m , k} + {n}_{k}}{- {x}_{1 , k , p}} ] - {x}_{1 , k} ‖}^{2} { Δ}_{=} arg {min}_{{wf}_{ 1} {w}_{b 1}} E ‖ {[ {w}^{H} s - {x}_{1 , k} ‖}^{2}$$

which is in the standard form of Wiener-Hopf filtering problem and the solution is given by the set of linear equations

E└_{SS}^{H}┘w=E└x_{1,k}^{*}S┘.

In order to obtain the correlation matrices in the above equation, statistical knowledge about the transmitted data streams and the noise is required. Without loss of generality, all of the data streams are assumed to be statistically independent and all the symbols are normalized random I.I.D within a data stream. Furthermore, the noise is assumed to be independent from data symbols. With these assumptions, the correlation matrices are computed, and equation 7 is expanded as:

$$[ \frac{{H}_{1 , c} {H}_{1 , c}^{H} + {H}_{1 , p} {H}_{1 , p}^{H} + {\sum }_{m = 2}^{M} {H}_{m} {H}_{m}^{H} + {R}_{nn}}{- {H}_{1 , p}^{H}} \begin{matrix}\vert \\ \vert\end{matrix} \frac{- {H}_{1 , p}}{I} ] [ \frac{{w}_{f 1}}{{w}_{b 1}} ] = [ \frac{{\tilde{h}}_{1}}{0} ]$$

Where \tilde{h}₁ is the (L+1)th column in the matrix H₁ counting from right and Rₙₙ=E└nₖnₖ^{H}┘ is the noise correlation matrix. Now the optimal filter of the biased design can be easily given as:

$${w}_{f 1 , B}^{+} = {[ {H}_{1 , c} {H}_{1 , c}^{H} + {\sum }_{m = 2}^{M} {H}_{m} {H}_{m}^{H} + {R}_{nn} ]}^{- 1} {\tilde{h}}_{1}$$

$${w}_{b l , B}^{+} = {H}_{1 , p}^{H} {w}_{f 1}$$

The MMSE-DFE prefilter 88, in one implementation, is biased. An easy way to see the bias is to observe that the MSE between the filter output z_{1,k} and the input symbol x_{1,k} is minimized. However, after the filter optimization the signal component in z_{1,k} is scaled by w_{f1}h₁ which is not of a value of 1 in general. Here we propose an unbiased MMSE-DFE prefilter with linear constraint to remove the bias. It can be analytically shown that the output SNR (OSNR) of the unbiased prefilter is the same as the biased prefilter, if the output SNR is properly defined.

To derive the unbiased MMSE-DFE prefilter, a linear constraint is used to make sure the bias is removed in the output signal:

w_{f1}⁺,w_{b1}⁺=arg min_{w}_{_{f1}}_{w}_{_{b1}}E∥z_{1,k}−x_{1,k}∥²=arg min_{w}_{_{f1}}_{w}_{_{bq}}E∥w_{f1}^{H}yₖ−w_{b1}^{H}x_{1,k,p}−x_{1,k}∥²s.t.w_{f1}^{H}\tilde{h}₁=1

where h₁ is defined above. Lagrange multipliers are used to obtain a solution. To facilitate the derivation, the causal part of input symbols x_{1,k,c} is broken into two parts: x_{1,k,c}=[x_{1,k,a}^{T};x_{1,k}]^{T} where x_{1,k} is the current symbol and x_{1,k,a}=[x_{k+K}, . . . xₖ₊₁]^{T} is the post-cursor part of the input symbols. Accordingly, we have H_{1,c}=[H_{1,a},h₁] where H_{1,a} and h₁ are the corresponding channel matrices for the post-cursor input symbols and the current data symbol. Now equation 5 can be rewritten as:

$${y}_{k} = {H}_{1 , p} {x}_{1 , k , p} + {H}_{1 , c} {x}_{1 , k , a} + {\tilde{h}}_{1} {x}_{1 , k} + {\sum }_{m = 2}^{M} {H}_{m} {x}_{m , k} + {n}_{k}$$

Substituting equation 11 and the linear constraint into the MSE expression, the following is obtained:

JΔE∥w_{f1}^{H}yₖ−w_{b1}^{H}x_{1,k,p}−x_{1,k}∥²

$$\begin{matrix}J { Δ}_{=} E {‖ {w}_{f 1}^{H} {y}_{k} - {w}_{b 1}^{H} {x}_{1 , k , p} - {x}_{1 , k} ‖}^{2} = E {‖ ( {w}_{f 1}^{H} {H}_{1 , p} - {w}_{b 1}^{H} ) {x}_{1 , k , p} + {w}_{f 1}^{H} ( {H}_{1 , a} {x}_{1 , k , a} + {\sum }_{m = 2}^{M} {H}_{m} {x}_{m , k} + {n}_{k} ) ‖}^{2} \\ = {‖ {w}_{f 1}^{H} {H}_{1 , p} - {w}_{b 1}^{H} ‖}^{2} + {w}_{f1}^{H} ( {H}_{1 , a} {H}_{1 , a}^{H} + {\sum }_{m = 2}^{M} {H}_{m} {H}_{m}^{H} + {R}_{n , n} ) {w}_{f 1}\end{matrix}$$

The same statistical properties of the variables are used as in the biased case. In order to minimize the MSE, it is easy to see that the first term is advantageously taken to zero to be zero, i.e. w_{b1}=H_{1,p}^{H}w_{f1}. By setting

$$V { Δ}_{=} {H}_{1 , a} {H}_{1 , a}^{H} + {\sum }_{m = 2}^{M} {H}_{m} {H}_{m}^{H} + {R}_{n , n}$$

the optimization of w_{f1} is reduced into:

w_{f1}⁺=arg min_{w}_{_{f1}}w_{f1}^{H}Vw_{f1}s.t.w_{f1}^{H}\tilde{h}₁=1

which can be easily solved by the Lagrange Multiplier method and the optimal solution is given by:

w_{f1,U}⁺=V⁻¹\tilde{h}₁(\tilde{h}₁^{H}V⁻¹\tilde{h}₁)⁻¹

w_{b1,U}⁺=H_{1,p}^{H}w_{f1}

The output signal to noise ratio (OSNR) is defined as the ratio of signal strength versus the noise and residue interference strength after prefiltering:

$$OSNR = \frac{E {‖ {w}_{f 1}^{H} {\tilde{h}}_{1} {x}_{1 , k} ‖}^{2}}{E {‖ {z}_{1 , k} - {w}_{f 1}^{H} {\tilde{h}}_{1} {x}_{1 , k} ‖}^{2}}$$

Upon analysis, both biased and unbiased prefilter can be shown to be substantially similar.

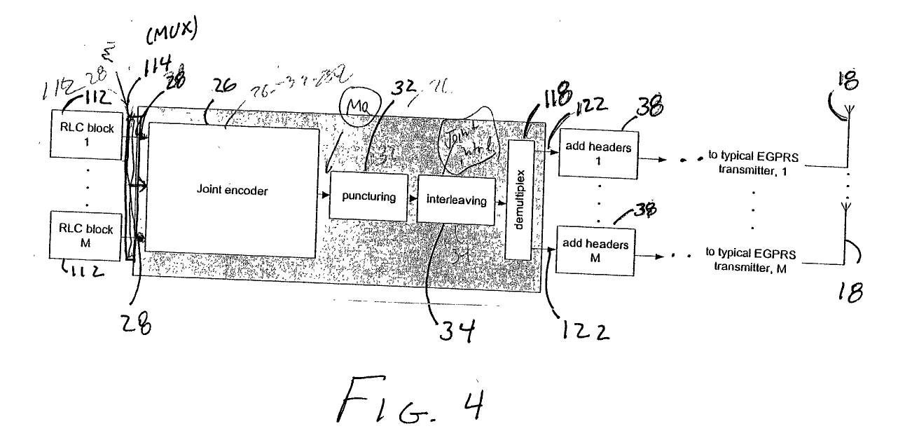

FIG. 4 illustrates a functional block diagram of apparatus of an embodiment of the present invention formed at the sending station 14 of the communication system 10 shown in FIG. 1. Here, M separate RLC blocks of data, indicated by the blocks 112, that are provided to a multiplexer 114 that generates multiplexed values on the lines 28 that are provided to a joint encoder 26. The joint encoder jointly encodes the data of each of the M blocks jointly. The jointly-encoded data is provided to a data puncturer 32 that performs selected puncturing operations upon the jointly-encoded data. And, an interleaver 34 interleaves values of the data provided thereto. Once interleaved, the data is demultiplexed by a demultiplexer 118. Once demultiplexed, separate lines 122 extend to separate subsequent blocks 38 of the sending station. And, thereafter, to each of the M transmit antennas 18.

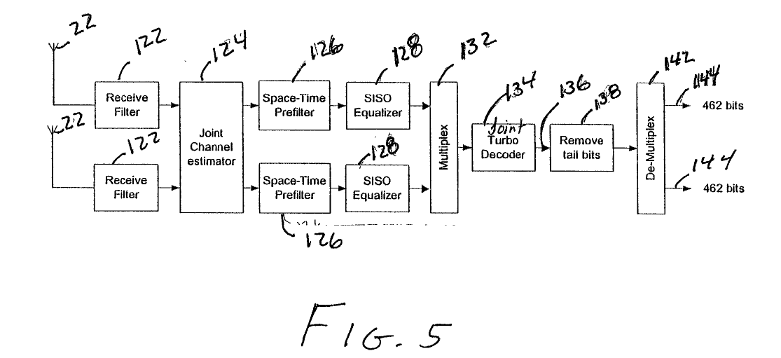

FIG. 5 illustrates corresponding structure positioned at the receiving station that operates to decode the jointly encoded data of the sending station 14 of the implementation shown in FIG. 4. Here, the receive antennas 22 again convert received data into electrical form and provide indications thereof to receive filter elements, here designated at 122. The receive filter elements generate filtered indications of the received data and provide such indications to a joint channel estimator 124. Joint estimations are performed responsive to all of the detected data on each of the receive antennas. Indications thereof are provided to separate space-time prefilter elements 126 and, thereafter, indications are provided to SISO (single input, single output) equalizer elements 128. The values generated by the separate equalizer elements are multiplexed together by a multiplexer 132. The multiplexed values are provided to a joint turbo decoder 134 (by turbo decoder we mean any decoder that iteratively passes soft information between decoding modules) that turbo-decodes the joint values. Decoded values are generated on the line 136, provided to an element 138 that removes tailbits out of the formatted data. Thereafter, the data is demultiplexed by a demultiplexer 142 and separate, demultiplexed, output values are generated on the lines 144.

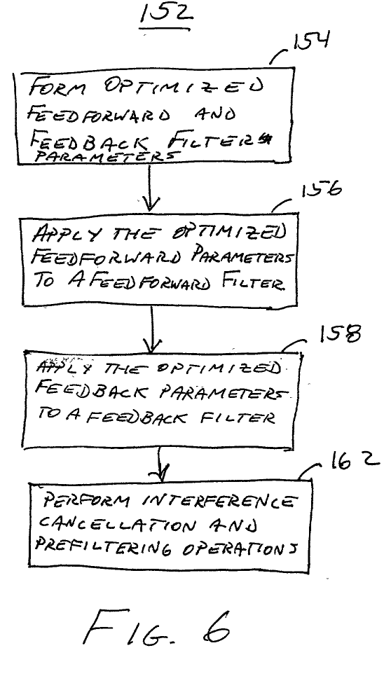

FIG. 6 illustrates a method, shown generally at 152, of an embodiment of the present invention. The method is operable in a multiple-input, multiple-output communication system having a receiving station that receives at least a first data vector. The method operates upon the data vector, once received at the receiving station.

First, and as indicated by the block 154, optimized feedforward filter parameters and optimized feedback filter parameters are formed. Then, and as indicated by the block 156, the optimized feedforward filter parameters are applied to a feedforward filter to define filter characteristics of the feedforward filter. And, as indicated by the block 158, the optimized feedback parameters are applied to a feedback filter to define the filter characteristics of the feedback filter.

Then, and as indicated by the block 162, interference cancellation and prefiltering operations are concurrently performed through operation of the prefilter 56 and DFSE 58.

The previous descriptions are of preferred examples for implementing the invention, and the scope of the invention should not necessarily be limited by this description. The scope of the present invention is defined by the following claims:

In the claims:

1. In a multiple-input, multiple-output communication system having a receiving station that receives at least a first data vector transmitted thereto upon a communication channel, the at least the first data vector formed of received symbols, an improvement of apparatus for operating upon the data vector, once received at the receiving station, said apparatus comprising:
at least a first processing element coupled to receive indications of the at least the first data vector received at the receiving station, said first processing element for forming optimized feedforward filter parameters and optimized feedback filter parameters, the optimized feedforward and feedback filter parameters used to perform interference cancellation and prefilter operations at the receiving station.

2. The apparatus of claim 1 wherein the receiving station further comprises at least a first feedforward filter coupled to receive indications of the at least the first data vector, wherein said first processing element is coupled to the first feedforward filter, and wherein the optimized feedforward filter parameters formed by said first processing element are provided to the first feedforward filter, values of the optimized feedforward parameters used at the first feedforward filter to define filter characteristics of the first feedforward filter and feedforward filtering operations performed upon the indications of the first data vector.

3. The apparatus of claim 2 wherein the at least the first data vector comprises the first data vector and at least a second data vector, wherein said at least the first processing element comprises the first processing element and at least a second processing element, wherein the at least the first feedforward filter comprises the first feedforward filter and at least a second feedforward filter, said second processing element coupled to the second feedforward filter, optimized feedforward parameters formed by said second processing element provided to the second feedforward filter, values thereof used at the second feedforward filter to define filter characteristics of the second feedforward filter.

4. The apparatus of claim 1 wherein the receiving station further comprises at least a first feedback filter coupled to receive indications of the at least the first data vector, wherein said first processing element is coupled to the first feedback filter, and wherein the optimized feedback filter parameters formed by said first processing element are provided to the first feedback filter, values of the optimized feedback parameters used at the first feedback filter to define filter characteristics thereof.

5. The apparatus of claim 4 wherein the at least the first data vector comprises the first data vector and at least a second data vector, wherein said at least the first processing element comprises said first processing element and at least a second processing element, wherein the at least the first feedback filter comprises the first feedback filter and at least the second feedback filter, said second processing element coupled to the second feedback filter, optimized feedback parameters formed by said second processing element provided to the second feedback filter, values thereof used at the second feedback filter to define filter characteristics of the second feedforward filter.

6. The apparatus of claim 4 wherein the receiving station further comprises at least a first feedforward filter coupled to received values representative of the first data vector, wherein said first processing element is coupled to the first feedforward filter and wherein the optimized feedforward filter parameters formed by said first processing element are provided to the first feedforward filter, values of the optimized feedforward parameters used at the first feedforward filter to define filter characteristics of the first feedforward filter, the first feedforward filter forming a first feedforward-filtered signal, the first feedforward-filtered signal forming the indications of the at least the first data vector.

7. The apparatus of claim 6 wherein the receiving station further comprises a sequence estimator and wherein the first feedback filter to which the optimized feedback parameters formed by said first processing element are provided form part of the sequence estimator.

8. The apparatus of claim 7 wherein the first feedforward filter to which the optimized feedforward parameters are provided by said first processing element form part of the sequence estimator.

9. The apparatus of claim 8 wherein application of the optimized feedforward and feedback parameters, respectively, to the feedforward and feedback filters, respectively, permits concurrent interference cancellation and prefilter operations to be performed at the sequence estimator.

10. The apparatus of claim 8 wherein the sequence estimator to which the feedforward and feedback parameters are provided by said first processing element comprises a decision feedback sequence estimator having a maximum likelihood sequence estimator to which the feedback filter is connected in a feedback arrangement.

11. The apparatus of claim 1 wherein the receiving station comprises a plurality of receive antenna elements and wherein said at least first processing element comprises a plurality of processing elements, said plurality of processing elements at least corresponding in number with the plurality of receive elements.

12. The apparatus of claim 11 wherein the receiving station is further comprised of a plurality of receive-chain portions, the plurality of receive-chain portions corresponding in number with the number of processing elements of said plurality of processing elements, a processing element of said plurality of processing elements forming part of each receive chain of the plurality of receive chains.

13. In the multiple-input, multiple-output communication system of claim 1 wherein the at least the first data vector is transmitted to the receiving station by a sending station, a further improvement of apparatus for the communication system, said apparatus comprising:
a joint encoder coupled to data that is to be sent to the receiving station, the send data formed of at least a first and a second data sequence, said joint encoder for jointly encoding the at least the first and second data sequences.

14. The further apparatus of claim 13 wherein said joint encoder further comprises a data puncturer for puncturing the encoded data encoded thereat.

15. The further apparatus of claim 14 wherein said joint encoder further comprises an interleaver for interleaving the encoded punctured data thereat.

16. In the multiple-input, multiple-output communication system of claim 15 wherein the apparatus for operating upon the data vector, once received at the receiving station, further comprises a joint decoder for performing joint decoding operations upon data representative of at least the first data vector.

17. In a method of communicating in a multiple-input, multiple-output communication system having a receiving station that receives at least a first data vector and transmitted thereto upon a communication channel, the at least the first data vector formed of received symbols, an improvement of a method for operating upon the data vector, once received at the receiving station, said method comprising:
forming optimized feedforward filter parameters and optimized feedback filter parameters;
applying the optimized feedforward filter parameters to a feedforward filter to define filter characteristics of the feedforward filter;
applying the optimized feedback filter parameters to a feedback filter to define filter characteristics of the feedback filter; and
concurrently performing interference cancellation and prefiltering operations through operation of the feedforward and feedback filters, respectively.

18. The method of claim 17 further comprising the operations, prior to said operation of forming, of:
jointly encoding input data at the sending station; and
transmitting the data, once encoded, to the receiving station.

19. The method of claim 18 comprising the further operation of jointly decoding indications of the at least the first data vector subsequent to performance of interference cancellation and prefiltering operations.

20. The method of claim 19 wherein said operation of concurrently performing the interference cancellation and prefiltering is performed at a decision feedback sequence estimator.
